(19) United States
(12) Patent Application Publication
(10) Pub. No.: US 2025/0311710 A1
(43) Pub. Date: Oct. 9, 2025

(54) METHOD AND APPARATUS FOR ACOUSTIC PEST DETECTION

(71) Applicant: Ecolab USA Inc., Saint Paul, MN (US)

(72) Inventors: Conor Sylvester Smith, Saint Louis Park, MN (US); Larry Arvid Lake, Woodbury, MN (US); Joelle Francine Olson, Hanover, MN (US); Julie Ellen Marquardt, Savage, MN (US); Tessa C. Scanlon, Asheville, NC (US)

(21) Appl. No.: 19/097,218

(22) Filed: Apr. 1, 2025

Related U.S. Application Data
(60) Provisional application No. 63/573,882, filed on Apr. 3, 2024.

(51) Int. Cl. A01M 1/02; G01N 29/34; G01N 29/44

(52) U.S. Cl. CPC A01M 1/026; G01N 29/341; G01N 29/4436; A01M 2200/011

(57) ABSTRACT

Various examples are directed to apparatus and methods for acoustic pest detection, to provide enhanced pest detection and enhanced battery life for a power supply of a pest detection device. The pest detection device includes an acoustic or vibration sensor and a controller connected to the acoustic or vibration sensor. The controller is configured to detect, identify, or detect and identify one or more pests based at least in part on comparing one or more signals received from the acoustic or vibration sensor with a predetermined sound or vibration profile of the one or more pests.

### CROSS-REFERENCE TO RELATED APPLICATION

This patent application claims the benefit of U.S. Provisional Patent Application No. 63/573,882, filed Apr. 3, 2024, which is incorporated by reference herein in its entirety.

### TECHNICAL FIELD

The present disclosure pertains to methods and apparatus for pest detection devices, and more particularly to methods and apparatus for a pest detection device with acoustic sensing.

### BACKGROUND

A number of devices are used to detect pests. One such device is an electronic sensor that detects the presence of a pest by measuring a change in capacitance due to a pest's presence on a capacitive sensor. Other examples include devices that incorporate pressure sensors or motion sensors. However, these devices have exhibited limitations in sensitivity and accuracy. In addition, some sensors for small pest detection must be recalibrated nearly continuously to achieve the desired sensitivity, and this recalibration requires electrical power and has a negative impact on battery life of wireless devices.

Another problem with present sensors is that smaller pests may be difficult to detect based on the sensor design. For example, a sensor that is configured for a certain insect of a certain size may not detect smaller insects, therefore also rendering inaccurate sensing results.

There is a need in the art for an improved pest detection device that will have longer battery life and better detect pests.

### SUMMARY

A system for pest detection device with acoustic sensing and improved battery life is provided. The present apparatus and methods provide a pest detection device including an acoustic sensor that may be used to verify the presence of a pest or to trigger the capture of the pest. Additionally, the acoustic sensor may be used to determine a pest type based on analysis of the sound profile generated by the pest as detected by the acoustic sensor. The present device may include a processor to analyze the sound profile and provide a comparison to a predetermined sound profile, and alternatively include wireless communication capability to communicate the sound profile to an external device for analysis. The device may also activate the acoustic sensor during programmable time intervals to manage power and data consumption for the sensor and device. In various embodiments, the pest detection device includes one or more additional or secondary sensors that monitor one or more prescribed conditions to trigger activation of the acoustic sensor to manage power consumption for the acoustic sensor. The secondary sensor or sensors may be deployed internally or externally to the pest detection device, and may work individually or in a coordinated manner to improve functioning of the device. Thus, the present subject matter ensures accurate pest detection and provides improved battery life compared to current devices.

Various examples are directed to apparatus and methods for enhanced pest detection and enhanced battery life for a power supply of a pest detection device. The pest detection device includes an acoustic or vibration sensor and a controller connected to the acoustic or vibration sensor. The controller is configured to detect, identify, or detect and identify one or more pests based at least in part on comparing one or more signals received from the acoustic or vibration sensor with a predetermined sound or vibration profile of the one or more pests.

Various examples are directed to a method for detecting pests using acoustic or vibration sensing. The method includes using an acoustic or vibration sensor with a pest detection device. The method further includes detecting, identifying, or detecting and identifying one or more pests using a controller connected to the acoustic or vibration sensor based at least in part on comparing one or more signals received by the controller from the acoustic or vibration sensor with a predetermined sound or vibration profile of the one or more pests.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

The drawings illustrate generally, by way of example, various embodiments discussed in the present document. The drawings are for illustrative purposes only and may not be to scale.

FIG. 1A is an illustration of a perspective view of a pest detection device showing components of the device, according to various embodiments.

FIG. 1B is an illustration of side view of the pest detection device of FIG. 1A, according to various embodiments.

FIG. 2 is an illustration of side view of a pest detection device including a trap, according to various embodiments.

FIGS. 3A-3C illustrate spectrograms generated using an acoustic sensor of a pest detection device, according to various embodiments.

FIG. 4 illustrates an example embodiment of a method for detecting or identifying pests using acoustic or vibration sensing, according to various embodiments.

FIG. 5 is a block diagram of a machine in the example form of a computer system within which a set of instructions may be executed, for causing the machine to perform any one or more of the methodologies discussed herein.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The scope of the present invention is defined by the appended claims, along with the full scope of legal equivalents to which such claims are entitled.

Prior pest detection devices have exhibited limitations in sensitivity and accuracy. In addition, some sensors for small pest detection must be recalibrated nearly continuously to achieve the desired sensitivity, and this recalibration requires electrical power and has a negative impact on battery life of wireless devices. Another problem with present sensors is that smaller pests may be difficult to detect based on the sensor design. For example, a sensor that is configured for a certain insect of a certain size may not detect smaller insects, therefore also rendering inaccurate sensing results.

The present subject matter provides a pest detection device with an acoustic or vibration sensor that may be used to verify the presence of a pest or to trigger the capture of the pest. Additionally, the acoustic or vibration sensor may be used to determine a pest type based on analysis of the sound profile generated by the sensor. The present device may include a processor to analyze the sound profile, and alternatively include wireless communication capability to communicate the sound profile to an external device for analysis. The device may also activate the acoustic or vibration sensor during programmable time intervals to manage power and data consumption for the device. In various embodiments, the pest detection device includes one or more additional or secondary sensors that monitor one or more prescribed conditions to trigger activation of the acoustic or vibration sensor to manage power consumption for the acoustic or vibration sensor. The secondary sensor or sensors may be deployed internally or externally to the pest detection device, and may work individually or in a coordinated manner to improve functioning of the device. Thus, the present subject matter ensures accurate pest detection and provides improved battery life compared to current devices.

For purposes of this disclosure an acoustic sensor is a sensor configured to detect vibrations generated from sounds, and a vibration sensor is a sensor that detects vibrations generally. Thus, an acoustic sensor is a type of vibration sensor.

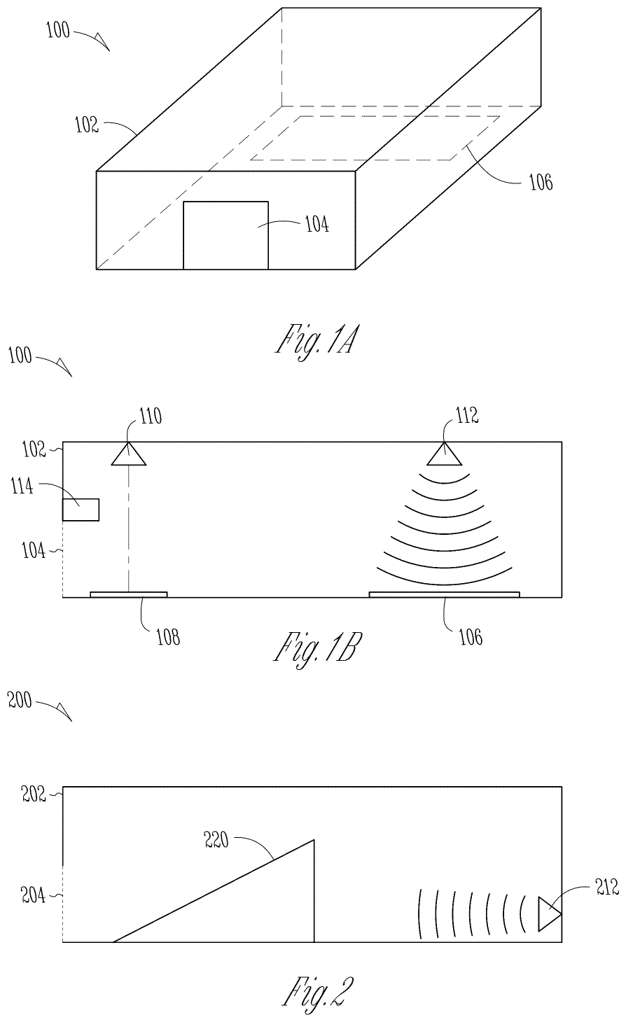

FIG. 1A is an illustration of a perspective view of a pest detection device 100 showing components of the device, according to various embodiments. In various embodiments, the pest detection device 100 includes a housing 102 with one or more openings, such as for an entrance 104 for pests. The pest detection device 100 may also include at least one mechanism to capture the one or more pests, such as glue board 106. Other mechanisms to capture the pests may be used, or mechanisms to capture the pests may be used in various examples. The pest detection device 100 is shown as a rectangular shape, but other shapes or designs may be used without departing from the scope of the present subject matter.

FIG. 1B is an illustration of side view of the pest detection device 100 of FIG. 1A, according to various embodiments. The pest detection device 100 includes an acoustic sensor 112 configured to be used to detect and/or identify one or more pests, in various examples. In other examples, a vibration sensor may be included and configured to be used to detect and/or identify one or more pests. The acoustic or vibration sensor may be located within the housing 102, or outside the housing 102, in various embodiments. In various examples, a controller (not shown) is connected to the acoustic or vibration sensor. The controller is configured to detect, identify, or detect and identify one or more pests based at least in part on comparing one or more signals received from the acoustic or vibration sensor with a predetermined sound or vibration profile of the one or more pests. In various examples, the predetermined sound or vibration profile of the one or more pests is stored in a storage location, such as a memory or database, accessible to the controller. The controller may be located within the housing 102, or outside the housing 102, in various embodiments. For example, the controller may be located in an external device in communication with the pest detection device 100.

In various examples, the pest detection device 100 may further include one or more secondary sensors connected to the controller and configured to detect one or more prescribed conditions. For example, the one or more secondary sensors may be used to identify the presence of pests for activation of the acoustic sensor 112, or for other functions of the pest detection device 100. Examples of the one or more secondary sensors include, but are not limited to, one or more of a capacitive sensor 108, an infrared sensor 110, a door switch sensor 114, and a pressure sensor. Other types of secondary sensors may be used, alone or in combination, without departing from the scope of the present subject matter. In various examples, the one or more secondary sensors may include a plurality of secondary sensors, and the plurality of secondary sensors may be of a same sensor type or may include multiple sensor types. In the depicted embodiment, the secondary sensors are disposed within the housing 102 of the pest detection device 100. However, the present subject matter is not so limited. Any of the secondary sensors may be disposed in the housing 102 of the device, or may be external to the device, on an internal or external surface of a housing of the device, or in another location, in various embodiments.

The one or more secondary sensors are configured to provide an activation signal to the controller, and the controller is configured to activate the acoustic or vibration sensor based at least in part on the activation signal, in various examples. In some examples, the controller is configured to activate the acoustic or vibration sensor on a programmable schedule. The pest detection device 100 may further include a battery configured to be used to provide electrical power to at least the controller, in some examples. In various embodiments, power may be provided by a plug for use with a conventional wall outlet. The device 100 may further include a display element such as a light emitting diode (LED) on a surface of the housing 102, or other type of display for providing device status or the like. In various examples, the pest detection device 100 may also include wireless communication electronics connected to the controller and configured to provide for wireless communications with one or more external devices.

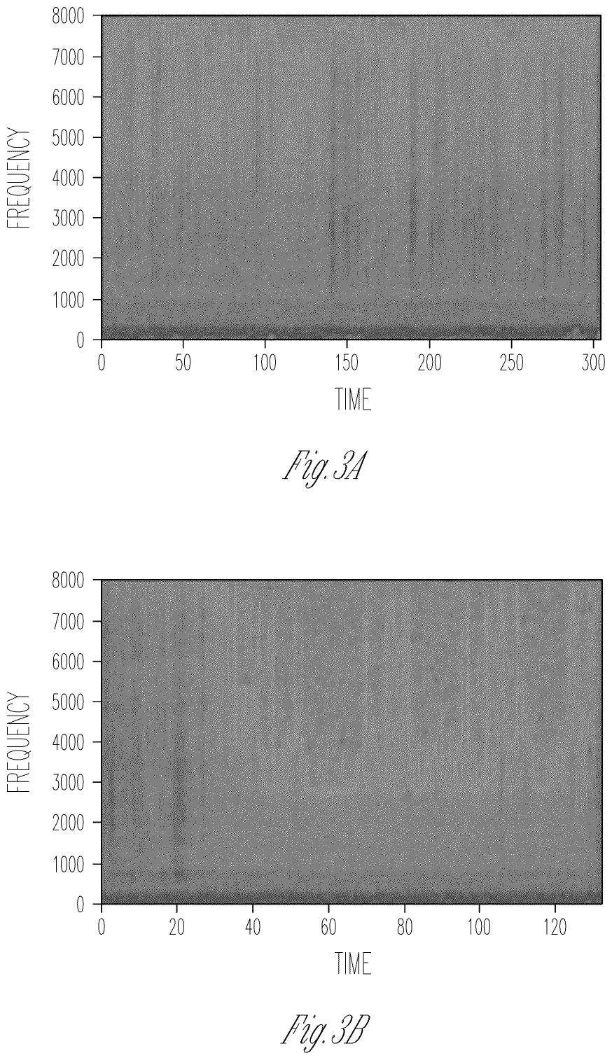

FIG. 2 is an illustration of side view of a pest detection device 200 including a trap, according to various embodiments. In the depicted embodiment, the pest detection device 200 includes a housing 202 with one or more openings, such as for an entrance 204 for pests. The pest detection device 200 may also include at least one mechanism to capture the one or more pests, such as pitfall trap 220. The pest detection device 200 includes an acoustic sensor 212 configured to be used to detect and/or identify one or more captured pests, in various examples. In other examples, a vibration sensor may be included and configured to be used to detect and/or identify one or more pests. The acoustic or vibration sensor may be located within the housing 202, or outside the housing 202, in various embodiments. In various examples, a controller (not shown) is connected to the acoustic or vibration sensor. The controller is configured to detect, identify, or detect and identify one or more pests based at least in part on one or more signals received from the acoustic or vibration sensor. The controller or processor may use machine learning to process the signals received from the acoustic or vibration sensor, in various embodiments. In various examples, the one or more signals include a sound profile of the one or more pests. The controller may be located within the housing 202, or outside the housing 202, in various embodiments. For example, the controller may be located in an external device in communication with the pest detection device 200. In various examples, the pest detection device 200 may further include one or more secondary sensors (not shown) connected to the controller and configured to detect one or more prescribed conditions. In some embodiments, the acoustic sensor 212 may be used to identify pests once trapped by the pitfall trap 220, glue board, or other mechanism for capturing, trapping or containing the pests.

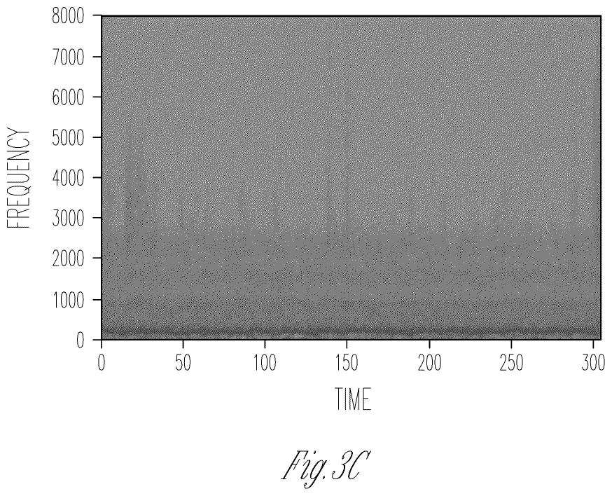

FIGS. 3A-3C illustrate spectrograms generated using an acoustic sensor of a pest detection device, according to various embodiments. FIG. 3A shows a spectrogram generated using an acoustic sensor that indicates the presence of pests, in this example cockroaches, in a calm state, in one embodiment. FIG. 3B shows a spectrogram generated using an acoustic sensor that indicates the presence of pests, in this example cockroaches, in an excited state, in an embodiment. FIG. 3C shows a spectrogram generated using an acoustic sensor that indicates an empty container, or the lack of presence of pests, in another embodiment. A controller, such as a microprocessor or microcontroller or other processing circuitry or logic, may be programmed to detect and/or identify the pests using the spectrograms, in various embodiments.

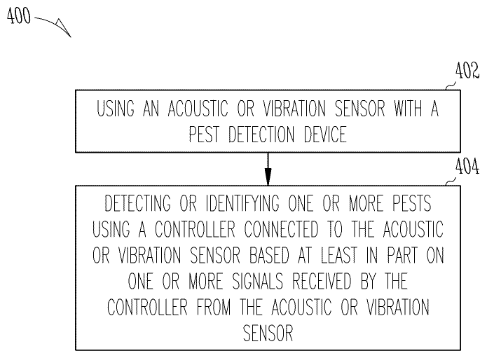

FIG. 4 illustrates an example embodiment of a method for detecting or identifying pests using acoustic or vibration sensing, according to various embodiments. The method 400 includes using an acoustic or vibration sensor with a pest detection device to detect characteristic signature sounds and/or vibrations associated with one or more pests (402). The method further includes detecting, identifying, or detecting and identifying one or more pests using a controller connected to the acoustic or vibration sensor based at least in part on one or more signals received by the controller from the acoustic or vibration sensor (404). In various embodiments, the method 400 further includes both detecting and identifying one or more pests using a controller connected to the acoustic or vibration sensor based at least in part on one or more signals received by the controller from the acoustic or vibration sensor.

In some embodiments, the method 400 further includes disposing the acoustic or vibration sensor in a housing for the pest detection device. The method 400 further includes disposing the controller in the housing, in some embodiments. The method 400 may further include disposing one or more secondary sensors in the housing, in various examples. In some examples, the method 400 further includes using wireless communication electronics to transmit the one or more signals from the acoustic or vibration sensor to the controller. A number of wireless protocols may be used by the present device to communicate and report pest detection results or other data to one or more external devices (such as a computer, a smartphone, a tablet, etc.), to other pest detection devices, to a router, to a gateway, or the like. The wireless standards that may be used by the present subject matter include, but are not limited to, one or more of the following: LoRa, near-field communication (NFC), Bluetooth, Bluetooth Low Energy (BLE), Ethernet, Wi-Fi, WiMax, ZigBee, or cellular standard communications such as 3G, 4G, LTE, 5G. Other wireless standards may be used without departing from the scope of the present subject matter.

The present subject matter provides a pest detection device which uses acoustics or vibration to detect and/or identify a captured pest. A pest monitoring device may house an acoustic/vibration sensor and may be coupled with an additional sensor to detect activity or employ a method such as glue board to capture a pest, in various examples. The acoustic/vibration sensor may be used to either verify the presence of a pest or to trigger the device to capture the pest, in various embodiments. Additionally or alternatively, the acoustic/vibration sensor may be used to determine a captured pest type based on sound profile generated. A processor may be used on the device to analyze acoustic/vibration data and determine likelihood of pest presence (e.g., using edge computing and/or machine learning), or the raw data may be sent to an external device or to the cloud for remote analysis. If it is determined that pest presence is likely, data may be sent either locally (e.g., using Bluetooth, ZigBee, Wi-Fi, LoRa, etc.) to a service associate, or to a central cellular gateway for further analysis and communication of activity to service associate.

A secondary sensor (e.g., capacitance, infrared, pressure switch, etc.) may be used to determine likely presence of pests which activates the acoustic/vibration sensor, in some examples. Additionally or alternatively, the acoustic/vibration sensor can be turned on during specific time intervals, in an effort to manage power consumption and data consumption for the acoustic/vibration sensor. The present pest monitoring device may include a mechanism or mechanisms to excite the captured pest to encourage activity, thereby creating acoustics which can be measured by the sensor, in some embodiments. The mechanisms include but are not limited to, a glue board, sound, vibration, light, and/or movement. These motivated pest acoustic/vibration emissions may assist with accuracy and consistency of monitoring of pests, in various examples.

The pest monitoring device may use an acoustic/vibration sensor either as a primary or secondary sensor to determine if a pest, such as an insect or a rodent, is present in the device. Other types of pests may be detected and/or identified without departing from the scope of the present subject matter. The acoustic/vibration sensor may use edge computing at a local controller to analyze the acoustic or vibration signature and determine the presence of one or more pests at the device, in various examples, which limits the amount of data used to confirm the presence of a pest. In various embodiments, the acoustic sensing can be used for other functions in place of or in addition to the detection or identification of pests.

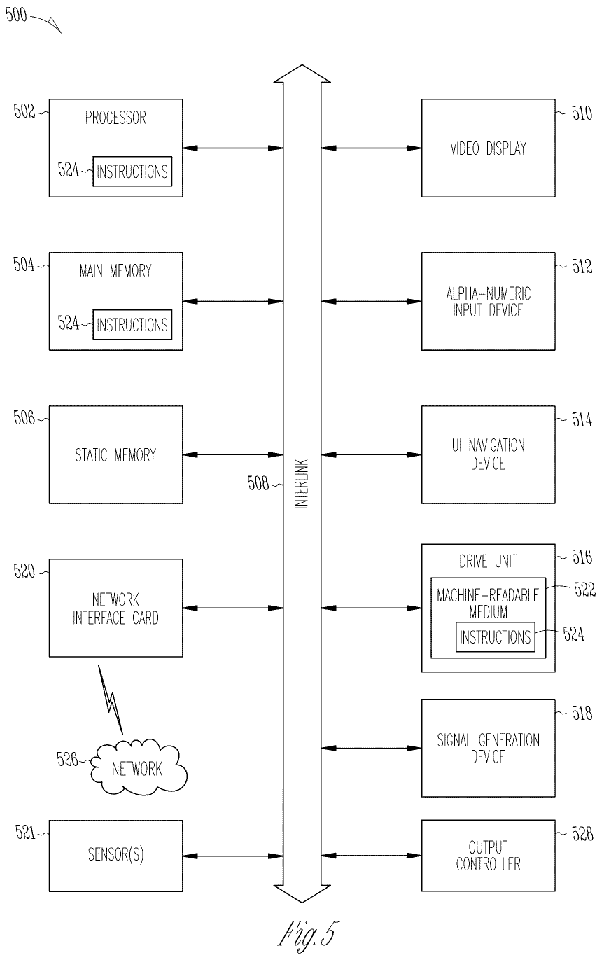

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be configured to perform the method of FIG. 2. The machine 500 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a central processing unit (CPU), a graphics processing unit (GPU), a hardware processor core, or any combination thereof), a controller, a microcontroller, a microprocessor, a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 524 may further be transmitted or received over a communications network 526 using a transmission medium via the network interface device 520. The Machine 500 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include wired and wireless communications, such as Ethernet, Bluetooth, Bluetooth Low Energy, other Personal Area Networks (PANs), LoRa, NFC, Wi-Fi, WiMAX, 3G, 4G, LTE, 5G, the unlicensed 915 MHz Industrial, Scientific, and Medical (ISM) frequency band, ZigBee, among others. Some standards may support mesh networks. The networks include, but are not limited to, a local area network (LAN), a low-power wide-area network (LPWAN), a wide area network (WAN), a packet data network (e.g., the Internet), mobile telephone networks (e.g., cellular networks), Plain Old Telephone (POTS) networks, and wireless data networks, e.g., Institute of Electrical and Electronics Engineers (IEEE) 802.11 family of standards known as Wi-Fi®, IEEE 802.16 family of standards known as WiMax®, NFC, IEEE 802.15.4 family of standards, a Long Term Evolution (LTE) family of standards, a Universal Mobile Telecommunications System (UMTS) family of standards, peer-to-peer (P2P) networks, among others. The NFC circuitry may be embodied as relatively short-range, high frequency wireless communication circuitry and may implement standards such as ECMA-340/ISO/IEC 18092 and/or ECMA-352/ISO/IEC 21481 to communicate with other devices. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

### OTHER NOTES AND EXAMPLES

Example 1 is a pest detection device including an acoustic sensor and a controller connected to the acoustic sensor, the controller configured to detect one or more pests based at least in part on comparing one or more acoustic signals received from the acoustic sensor with a predetermined sound profile associated with the one or more pests.

In Example 2, the subject matter of Example 1 optionally includes wherein the controller is configured to identify the one or more pests based at least in part on the one or more signals received from the acoustic sensor.

In Example 3, the subject matter of Example 1 optionally includes wherein the acoustic sensor and the controller are disposed within a housing.

In Example 4, the subject matter of Example 1 optionally includes wherein the acoustic sensor is disposed in a first housing and the controller is disposed within a second housing.

In Example 5, the subject matter of Example 1 optionally includes wherein the controller is disposed within a housing and the acoustic sensor is external to the housing.

In Example 6, the subject matter of Example 1 optionally includes wherein the predetermined sound profile includes a sound profile of a cockroach.

In Example 7, the subject matter of Example 1 optionally further includes at least one mechanism to capture the one or more pests.

In Example 8, the subject matter of Example 1 optionally further includes one or more secondary sensors connected to the controller and configured to detect one or more prescribed conditions.

In Example 9, the subject matter of Example 8 optionally includes wherein the one or more secondary sensors include one or more of a capacitive sensor, an infrared sensor, or a pressure sensor.

In Example 10, the subject matter of Example 8 optionally includes wherein the one or more secondary sensors are configured to provide an activation signal to the controller, and the controller is configured to activate the acoustic sensor based at least in part on the activation signal.

In Example 11, the subject matter of Example 1 optionally includes wherein the controller is configured to activate the acoustic sensor on a programmable schedule.

In Example 12, the subject matter of Example 1 optionally includes wherein the controller is configured to use machine learning to detect or identify the one or more pests based at least in part on one or more signals received from the acoustic sensor.

In Example 13, the subject matter of Example 1 optionally further includes wireless communication electronics connected to the controller and configured to provide for wireless communications with one or more external devices.

Example 14 is a method including using an acoustic sensor with a pest detection device and detecting one or more pests using a controller connected to the acoustic sensor based at least in part on comparing one or more signals received by the controller from the acoustic sensor with a predetermined sound profile associated with the one or more pests.

In Example 15, the subject matter of Example 14 optionally further includes identifying one or more pests using a controller connected to the acoustic sensor based at least in part on one or more signals received by the controller from the acoustic sensor.

In Example 16, the subject matter of Example 14 optionally further includes disposing the acoustic sensor in a housing for the pest detection device.

In Example 17, the subject matter of Example 16 optionally further includes disposing the controller in the housing.

In Example 18, the subject matter of Example 16 optionally further includes disposing one or more secondary sensors in the housing.

In Example 19, the subject matter of Example 14 optionally further includes using wireless communication electronics to transmit the one or more signals from the acoustic sensor to the controller.

In Example 20, the subject matter of Example 19 optionally includes wherein the wireless communication electronics are compatible with one or more of cellular, Bluetooth, ZigBee, Wi-Fi or LoRa communications.

Example 21 is a pest detection device including a vibration sensor and a controller connected to the vibration sensor, the controller configured to detect one or more pests based at least in part on comparing one or more vibration signals received from the vibration sensor with a predetermined vibration profile of the one or more pests.

In Example 22, the subject matter of Example 21 optionally includes wherein the controller is configured to identify the one or more pests based at least in part on the one or more signals received from the vibration sensor.

In Example 23, the subject matter of Example 21 optionally includes wherein the vibration sensor and the controller are disposed within a housing.

In Example 24, the subject matter of Example 21 optionally includes wherein the vibration sensor is disposed in a first housing and the controller is disposed within a second housing.

In Example 25, the subject matter of Example 21 optionally includes wherein the controller is disposed within a housing and the vibration sensor is external to the housing.

In Example 26, the subject matter of Example 21 optionally includes wherein predetermined vibration profile includes a vibration profile of a cockroach.

In Example 27, the subject matter of Example 21 optionally further includes at least one mechanism to capture the one or more pests.

In Example 28, the subject matter of Example 21 optionally further includes one or more secondary sensors connected to the controller and configured to detect one or more prescribed conditions.

In Example 29, the subject matter of Example 28 optionally includes wherein the one or more secondary sensors include one or more of a capacitive sensor, an infrared sensor, or a pressure sensor.

In Example 30, the subject matter of Example 28 optionally includes wherein the one or more secondary sensors are configured to provide an activation signal to the controller, and the controller is configured to activate the vibration sensor based at least in part on the activation signal.

In Example 31, the subject matter of Example 21 optionally includes wherein the controller is configured to activate the vibration sensor on a programmable schedule.

In Example 32, the subject matter of Example 21 optionally includes wherein the controller is configured to use machine learning to detect or identify the one or more pests based at least in part on one or more signals received from the vibration sensor.

In Example 33, the subject matter of Example 21 optionally further includes wireless communication electronics connected to the controller and configured to provide for wireless communications with one or more external devices.

Example 34 is a method including using a vibration sensor with a pest detection device and detecting one or more pests using a controller connected to the vibration sensor based at least in part on comparing one or more signals received by the controller from the vibration sensor with a predetermined vibration profile of the one or more pests.

In Example 35, the subject matter of Example 34 optionally further includes identifying one or more pests using a controller connected to the vibration sensor based at least in part on one or more signals received by the controller from the vibration sensor.

In Example 36, the subject matter of Example 34 optionally further includes disposing the vibration sensor in a housing for the pest detection device.

In Example 37, the subject matter of Example 36 optionally further includes disposing the controller in the housing.

In Example 38, the subject matter of Example 36 optionally further includes disposing one or more secondary sensors in the housing.

In Example 39, the subject matter of Example 34 optionally further includes using wireless communication electronics to transmit the one or more signals from the vibration sensor to the controller.

In Example 40, the subject matter of Example 39 optionally includes wherein the wireless communication electronics are compatible with one or more of cellular, Bluetooth, ZigBee, Wi-Fi or LoRa communications.

Example 41 is at least one machine-readable medium including instructions that, when executed by processing circuitry, cause the processing circuitry to perform operations to implement of any of Examples 1-40.

Example 42 is an apparatus comprising means to implement of any of Examples 1-

40.

Example 43 is a system to implement of any of Examples 1-40.

Example 44 is a method to implement of any of Examples 1-40.

The foregoing examples are not intended to be an exhaustive or exclusive list of examples and variations of the present subject matter. The above description is intended to be illustrative, and not restrictive. Those of skill in the art will appreciate additional variations of the embodiments that can be used within the scope of the teachings set forth herein. The scope of the invention should be determined with reference to the appended claims, along with the full scope of equivalents to which such claims are entitled.

What is claimed is:

1. A pest detection device, comprising:
an acoustic sensor; and
a controller connected to the acoustic sensor, the controller configured to detect one or more pests based at least in part on comparing one or more acoustic signals received from the acoustic sensor with a predetermined sound profile associated with the one or more pests.

2. The pest detection device of claim 1, wherein the controller is configured to identify the one or more pests based at least in part on the one or more signals received from the acoustic sensor.

3. The pest detection device of claim 1, wherein the acoustic sensor and the controller are disposed within a housing.

4. The pest detection device of claim 1, wherein the acoustic sensor is disposed in a first housing and the controller is disposed within a second housing.

5. The pest detection device of claim 1, wherein the controller is disposed within a housing and the acoustic sensor is external to the housing.

6. The pest detection device of claim 1, wherein the predetermined sound profile includes a sound profile of a cockroach.

7. The pest detection device of claim 1, further comprising at least one mechanism to capture the one or more pests.

8. The pest detection device of claim 1, further comprising one or more secondary sensors connected to the controller and configured to detect one or more prescribed conditions.

9. The pest detection device of claim 8, wherein the one or more secondary sensors include one or more of a capacitive sensor, an infrared sensor, or a pressure sensor.

10. The pest detection device of claim 8, wherein the one or more secondary sensors are configured to provide an activation signal to the controller, and the controller is configured to activate the acoustic sensor based at least in part on the activation signal.

11. The pest detection device of claim 1, wherein the controller is configured to activate the acoustic sensor on a programmable schedule.

12. The pest detection device of claim 1, wherein the controller is configured to use machine learning to detect or identify the one or more pests based at least in part on one or more signals received from the acoustic sensor.

13. The pest detection device of claim 1, further comprising wireless communication electronics connected to the controller and configured to provide for wireless communications with one or more external devices.

14. A method, comprising:
using an acoustic sensor with a pest detection device; and
detecting one or more pests using a controller connected to the acoustic sensor based at least in part on comparing one or more signals received by the controller from the acoustic sensor with a predetermined sound profile associated with the one or more pests.

15. The method of claim 14, further comprising identifying one or more pests using a controller connected to the acoustic sensor based at least in part on one or more signals received by the controller from the acoustic sensor.

16. The method of claim 14, further comprising disposing the acoustic sensor in a housing for the pest detection device.

17. The method of claim 16, further comprising disposing the controller in the housing.

18. The method of claim 16, further comprising disposing one or more secondary sensors in the housing.

19. The method of claim 14, further comprising using wireless communication electronics to transmit the one or more signals from the acoustic sensor to the controller.

20. The method of claim 19, wherein the wireless communication electronics are compatible with one or more of cellular, Bluetooth, ZigBee, Wi-Fi or LoRa communications.
